(19) United States
(12) Patent Application Publication
(10) Pub. No.: US 2011/0127065 A1
(43) Pub. Date: Jun. 2, 2011

(54) ELECTRIC CABLE FOR NUCLEAR POWER PLANTS WITH IMPROVED DURABILITY AND FABRICATION METHOD THEREOF

(76) Inventor: Chan-Yong PARK, Gunpo-si (KR)

(21) Appl. No.: 12/911,941

(22) Filed: Oct. 26, 2010

(30) Foreign Application Priority Data
Nov. 30, 2009 (KR) 10-2009-0116631

(51) Int. Cl. H01B 3/00; B05D 5/12

(52) U.S. Cl. 174/110 R; 427/120

(57) ABSTRACT

Disclosed is a method for fabricating an electric cable for nuclear power plants, comprising: pre-heating a conductor wire; melting a PEEK (poly ether ether ketone) material and extruding the PEEK material in the direction of the conductor wire, to form an insulator such that the insulator coats the surface of the conductor wire; and cooling the insulator quickly.

### CROSS-REFERENCE TO RELATED APPLICATION

This application claims priority to Korean Patent Application No. 10-2009-0116631 filed in Republic of Korea on Nov. 30, 2009, the entire contents of which are incorporated herein by reference.

### BACKGROUND OF THE INVENTION

1. Field of the Invention

The present invention relates to an electric cable for nuclear power plants, and in particular, to an electric cable for nuclear power plants that is made from a material with activation energy suitable for long-term use of nuclear power plants, and a fabrication method thereof.

2. Description of the Related Art

Electric cables for nuclear power plants are installed at various kinds of equipments in the nuclear power plants, and used to transfer power, sensor or control signals and so on.

Electric cables for nuclear power plants continue to be exposed to gamma rays or a type of radiation having high permeability and destructive power, and due to such special usage environment, they need physical and chemical properties different from general electric cables.

Typically, electric cables for nuclear power plants are subject to a high reliability test in consideration of a long-term operation of 40 years or longer. The total integrated dose for 40 years is estimated between 30 and 40 Mrad, and a nuclear power plant's containment building is designed to sustain a high temperature atmosphere, and when the nuclear power plant operates continuously, the temperature of the containment building reaches 90° C. As mentioned above, electric cables for nuclear power plants are used at a severer temperature atmosphere than typical polymer material-based electric cables.

Further, nuclear power plants prepare for the worst simulated accidents such as coolant leakage, and in this context, nuclear power plants pass through a design base event (DBE) testing to test whether they sufficiently resist the situations to be confronted subsequently to coolant leakage, for example, the situation where they are exposed to a large amount of radioactive substances, an ultra high temperature/high pressure atmosphere and a large amount of chemicals. This testing is important, because if electric cables used to connect various kinds of control equipments do not endure such simulated testing and are damaged, the worst accidents may occur such as damage of a nuclear reactor and subsequent radioactive leakage at nearby villages, before measures are taken to minimize damage of nuclear power plants.

For this reason, electric cables for nuclear power plants should meet the standards for radioactivity resistance, heat resistance, chemical resistance, long-term reliability and so on, and related studies have been made to achieve the goal. Recently, as interests are increasingly taken in 4th generation nuclear power plants that excel the existing 3rd generation and 3.5-generation nuclear power plants in use, attempts have been made to develop electric cables for the new-generation nuclear power plants that can guarantee an ultra long-term operation of 60 years or longer.

Conventionally, electric cables for nuclear power plants have used EPR family, chloroprene rubber (CR) or chloro-sulfonated polymer (CSP), as a coating material for a long time.

In case where EPR or CR is used, a proton donating antioxidant, for example, Kumanox RD as a quinolinic antioxidant, Irganonox 1010 as a phenolic antioxidant, etc., was added to prevent deterioration in electrical properties that may occur due to oxidizing deterioration caused by radiation. However, studies on the type and a proper amount of the antioxidant are insufficient.

Generally, it is possible to estimate 40-year durability of electric cables for nuclear power plants by calculating activation energy of a coating material by thermogravimetric analysis (TGA) or elongation retention, and determining the accelerated aging (deterioration) temperature and time according to IEEE standards using Arrhenius model. The following mathematical formula I concerns an Arrhenius model, and shows the correlation between accelerated aging temperature and accelerated aging time when activation energy is determined. In the mathematical formula 1, t_{SER} (operating time at normal temperature) is 40 years, t_{AG} (accelerated aging time) is 769 hours, Φ (activation energy) is 1.35 eV, T_{SER} (normal operating temperature) is 90° C. (=363.16 k), T_{AG} (accelerated aging temperature) is 150° C. (=423.16 k), and K(Boltzmann constant) is 8.617×10⁻⁵ eV/k.

$${t}_{SER} = {t}_{AG} exp ( ( \frac{φ}{K} ) \times ( \frac{1}{{T}_{SER}} - \frac{1}{{T}_{AG}} ) ) \qquad [ Mathematical formula 1 ]$$

The activation energy of a material such EPR or CR is usually determined between 1.35 and 1.4 eV because of intrinsic properties of a polymer material. In this case, to guarantee 40 year durability, electric cables should meet the standard for thermal aging time at least between 700 and 800 hours at an accelerated aging temperature of 150° C.

To guarantee 60 year durability under the same activation energy conditions as 40 year durability, electric cables should meet the standard for thermal aging time between 1,100 and 1,300 hours at 150° C. And, the total integrated dose for 60 years is between 50 and 60 Mrad, and in DBE testing, the electric cables are further exposed to radiation between 160 and 200 Mrad at once, which results in fatal problems to a sample that came up to the limits.

Considering the above matters, it is difficult to fabricate electric cables for nuclear power plants with guaranteed 60-year durability using the existing multi-purpose polymer materials (for example, EPR, PVE, PO, etc.), and accordingly, improvements should be done with the existing cable materials and fabrication processes to build 4th generation nuclear power plants.

### SUMMARY OF THE INVENTION

The present invention is designed to solve the problem, and it is an object of the present invention to provide an electric cable for nuclear power plants that has an improved coating material capable of an ultra long-term operation at a high-temperature exposure environment, and a fabrication method thereof.

To achieve the object, an electric cable for nuclear power plants according to the present invention comprises at least one core consisted of a conductor and an insulator coating the conductor, wherein the insulator is made from an engineering polymer (EP) material.

The engineering polymer is preferably poly ether ether ketone (PEEK).

The insulator is preferably amorphitized and transparent.

The insulator preferably has activation energy between 2.0 and 2.8 eV.

The insulator preferably has elongation between 150 and 200%.

In addition, the electric cable for nuclear power plants may further comprise a sheath surrounding the core.

According to another aspect, the present invention provides a method for fabricating an electric cable for nuclear power plants with a conductor and an insulator coating the conductor, comprising: pre-heating a conductor wire; melting a poly ether ether ketone (PEEK) material and extruding the material in the direction of the conductor wire, to form an insulator such that the insulator coats the surface of the conductor wire; and cooling the insulator quickly.

At the pre-heating step, the conductor wire is preferably pre-heated to a temperature between 150 and 200° C.

At the extrusion step, the temperature of a die head of an extruder is preferably set between 390 and 410° C. to melt the PEEK material.

At the quick cooling step, the PEEK material is preferably amorphitized by applying a coolant between 0 and 10° C.

### EFFECTS OF THE PRESENT INVENTION

An electric cable for nuclear power plants according to the present invention has an amorphous PEEK insulator, and thus exhibits excellent tensile strength, elongation and flexibility, and is easy to peel off its coating. Also, it has a high insulation resistance, which allows formation of a thin insulator, leading to a compact design.

### BRIEF DESCRIPTION OF THE DRAWINGS

The accompanying drawings illustrate the preferred embodiments of the present invention and are included to provide a further understanding of the spirit of the present invention together with the detailed description of the invention, and accordingly, the present invention should not be limitedly interpreted to the matters shown in the drawings.

FIG. 1 is a cross-sectional view showing a main structure of an electric cable for nuclear power plants according to a preferred embodiment of the present invention.

FIG. 2 is a cross-sectional view showing a modified example of FIG. 1.

FIG. 3 is a photograph showing an actual appearance of an electric cable for nuclear power plants according to the present invention.

FIG. 4 is a photograph showing an actual appearance of electric cables for nuclear power plants according to an embodiment of the present invention and a comparative example.

FIG. 5 is a photograph showing the damaged state of an electric cable for nuclear power plants according to a comparative example.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

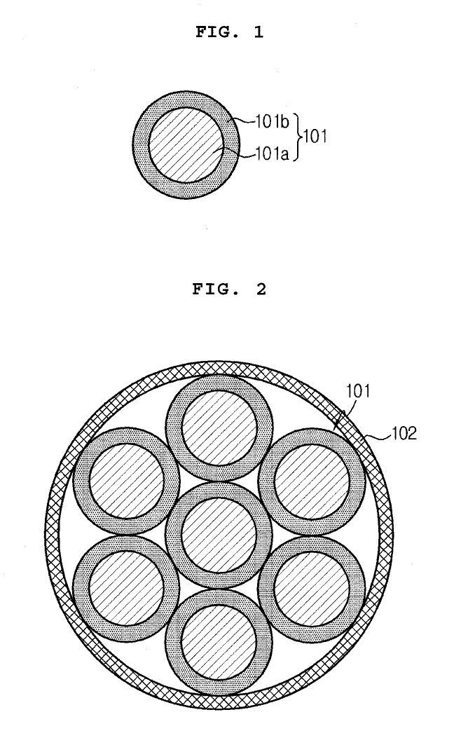

FIG. 1 is a cross-sectional view showing a main structure of an electric cable for nuclear power plants according to a preferred embodiment of the present invention.

Referring to FIG. 1, the electric cable for nuclear power plants according to a preferred embodiment of the present invention has a core 101 with an insulation coating of engineering polymer (EP). That is, the core 101 of the electric cable for nuclear power plants has a conductor 101a, and an insulator 101b coating the conductor 101a and made from engineering polymer.

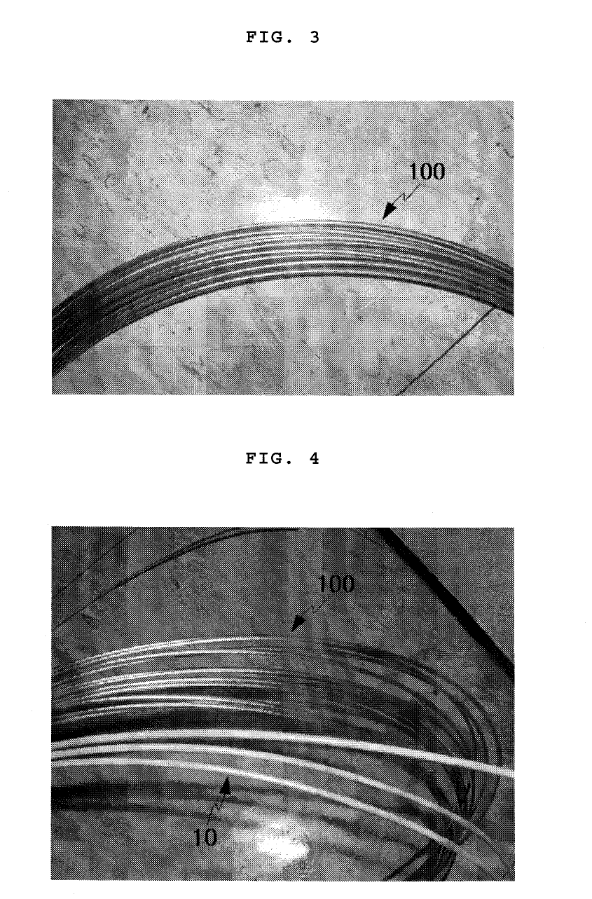

The electric cable for nuclear power plants may be provided as a wire cable with a single core, or as a multi-core cable comprising a plurality of cores 101 and an outmost sheath 102, as shown in FIG. 2.

The insulator 101b is formed from PEEK (Poly Ether Ether Ketone), i.e., engineering polymer having high activation energy between 2.0 and 2.8 eV. The high activation energy between 2.0 and 2.8 eV provides an ultra long-term durability of 60 years or longer at normal operating temperature of 90° C. where nuclear power plants are generally run.

The engineering polymer is a polymer material requiring a processing temperature of 250° C. or above that is higher than that of a typical polymer material, i.e., 100° C. The engineering polymer may include polyamide, polyacetal, polycarbonate, poly butylenes telephtalate (PET), polyphenylene oxide (PPO), PEEK or the like. These exemplary engineering polymers commonly have a molecular weight between several hundred thousands and several millions, unlike conventional polymer materials having a low molecular weight between several tens and several hundreds. In particular, PEEK is better than the other polymer materials in aspects of strength, elasticity, impact resistance, abrasion resistance, weather resistance, chemical resistance, electrical insulation or the like, and above all, it has excellent radioactivity resistance, and thus, is most suitable for an insulator material of an electric cable for nuclear power plants.

When the insulator 101b of PEEK is subject to an exposure test of 300 Mrad, no crack occurs at bending. This is caused by an aromatic ring structure. This feature allows an electric cable for nuclear power plants to satisfy Q safety class without a separate sheath or jacket.

The insulator 101b is formed by coating the conductor 101a with an insulator material by an extrusion process, followed by amorphitization, which make the insulator 101b transparent to observe the conductor 101a from the outside. This structure leads to a wire cable 100 with convenient observation of the inside of the core, good appearance and easy peel-off as shown in FIG. 3. And, the amorphous insulator 101b exhibits good flexibility and high elongation between 150 and 200%.

If the insulator 101b of PEEK maintains high crystallinity, an electric cable becomes very stiff and has a low elongation of 30% or less, and in case the insulator 101b is formed with a large diameter of 2 mm or more, it is not easy to peel off the insulator 101b from the conductor 101, and when the insulator 101b is forcedly peeled off, the insulator 101b may break together with the conductor 101.

The present invention provides a method for fabricating an electric cable for nuclear power plants using PEEK.

A method for fabricating an electric cable for nuclear power plants according to the present invention comprises a process for pre-heating a conductor wire, a process for extruding PEEK on the conductor wire to form an insulator such that the surface of the conductor wire is coated with the insulator, and a process for cooling the insulator.

The preheating process heats the conductor wire to a high temperature between 150 and 200° C., and is used to prevent the extruded PEEK melt from being cooled due to contact with the conductor wire.

The extrusion process heats a die head of an extruder to a higher temperature than a melting temperature of PEEK, i.e., 340° C., melts the PEEK, and extrudes the PEEK melt on the conductor wire in the direction of the conductor wire to form an insulator such that the surface of the conductor wire is coated with the insulator. Preferably, the temperature of the die head is set between 390 and 410° C.

The cooling process cools the insulator quickly by applying a coolant to the die head. Thereby the insulator becomes amorphous and transparent, and has a high elongation.

The temperature of the coolant applied to the die head is preferably set between 0 and 10° C. for effective amorphitization.

### Embodiment

A 60-year-durability-guarantee electric cable for nuclear power plants was designed, with a conductor of 16 AWG (American Wire Gauge) thickness and a PEEK insulator having an outer diameter of 1.98 mm and a thickness of 0.32 mm.

A 25 mm extruder for extruding a PEEK material was provided, and a pre-heater for pre-heating the conductor prior to extrusion and a chiller for quickly cool down the PEEK material discharged from a dice of the extruder are provided.

The temperature of the die head of the extruder was set to 399° C., and dry temperature of the extruder was set to 150° C. in consideration of the hygroscopic property of the PEEK material. And, the temperature of the pre-heater was set to heat the conductor to 160° C., and the chiller was installed at an exit of the dice of the extruder to cool a coolant of 2° C.

Under the above-mentioned conditions, the PEEK material was extruded while changing from army green to transparent gold by absolute cooling, and became amorphous and flexible, and at this time, elongation was about 190%. In this way, a wire cable 100 in which the conductor is observable through the transparent PEEK insulator was fabricated as shown in FIG. 4.

According to the thermogravimetric analysis (TGA), the resulting cable 100 has activation energy of 2.5 eV. And, as shown in the below table 1, even after thermal aging and 300 Mrad radiation exposure, the electric cable 100 maintained its state well, and passed a LOCA (Loss Of Coolant Accident) test to meet the safety standard of nuclear power plants and endured an in-water pressure resistance testing of 2.5 kV/5 minutes. Furthermore, according to Arrhenius model, the electric cable 100 offered 60 year durability guarantee without bending crack, under continuous temperature conditions of 90° C.

TABLE 1

| | | Material | Processing | | Thermal aging | 300 Mrad | | Estimated durability |
|---|---|---|---|---|---|---|---|---|
| Classifi- | Raw | (Insulator/ | temperature | Activation | under 60 year | radiation | LOCA | under normal |
| cation | material | Sheath) | (° C.) | energy(eV) | condition | exposure | testing | conditions |
| Compar- | Conven- | EPR/CSP | 100 | 1.35 | poor | cracks | cracks | 40 years |
| ative | tional | | | | | | | |
| example | polymer | | | | | | | |
| Embodi- | Engi- | Amorphous | 400 | 2.5 | good | good | good | 60 years |
| ment | neering | PEEK | | | | | | |
| | plastic | | | | | | | |

### Comparative Example

An electric cable for nuclear power plants with an insulator of EPR and a sheath of CSP was designed.

The electric cable 10 for nuclear power plants, coated with a sheath by a conventional cable extrusion process, was fabricated as shown in FIG. 4.

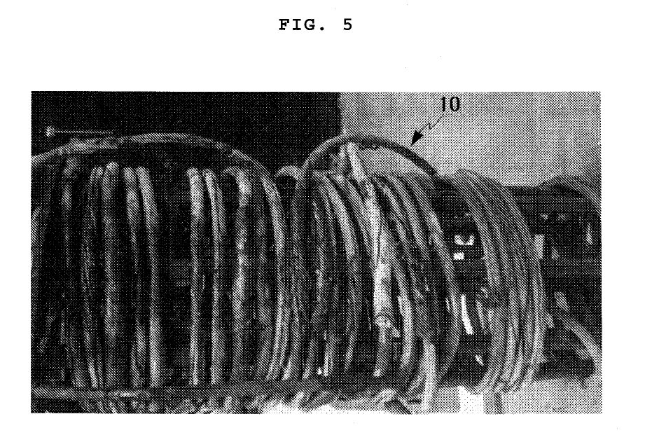

According to the thermogravimetric analysis (TGA), the electric cable 10 has activation energy of 1.4 eV. Thus, after thermal aging and 300 Mrad radiation exposure, the electric cable 10 was severely damaged and suffered from bending cracks as shown in FIG. 5, and failed a LOCA test and did not meet the safety standard of nuclear power plants. And, according to Arrhenius model, the electric cable 10 offered 40 year durability guarantee under continuous temperature conditions of 90° C., but had difficulty in offering 60 year durability guarantee.

As mentioned above, the present invention can fabricate an electric cable for nuclear power plants with guaranteed ultra long-term durability by making a PEEK material amorphous during a cable extrusion process.

Hereinabove, the present invention is described with reference to the limited embodiments and drawings. However, the description proposed herein is just a preferable example for the purpose of illustrations only, not intended to limit the scope of the invention, so it should be understood that other equivalents and modifications could be made thereto without departing from the spirit and scope of the invention.

### INDUSTRIAL APPLICABILITY

The electric cable for nuclear power plants according to the present invention has an insulation coating of PEEK high activation energy, and accordingly, can be successfully applied to nuclear power plants requiring an ultra long-term durability of 60 years or longer.

What is claimed is:

1. An electric cable for nuclear power plants, comprising:
at least one core including a conductor and an insulator coating the conductor,
wherein the insulator is made from an engineering polymer (EP) material.

2. The electric cable for nuclear power plants according to claim 1,
wherein the engineering polymer is poly ether ether ketone (PEEK).

3. The electric cable for nuclear power plants according to claim 2,
wherein the insulator is amorphitized and transparent.

4. The electric cable for nuclear power plants according to claim 2,
wherein the insulator has activation energy between 2.0 and 2.8 eV.

5. The electric cable for nuclear power plants according to claim 2,
wherein the insulator has elongation between 150 and 200%.

6. The electric cable for nuclear power plants according to claim 1, further comprising:
a sheath surrounding the core.

7. A method for fabricating an electric cable for nuclear power plants with a conductor and a sheath coating the conductor, the method comprising:
pre-heating a conductor wire;
melting a poly ether ether ketone (PEEK) material and extruding the PEEK material in the direction of the conductor wire, to form an insulator such that the insulator coats the surface of the conductor wire; and
cooling the insulator quickly.

8. The method for fabricating an electric cable for nuclear power plants according to claim 7,
wherein the conductor wire is pre-heated to a temperature between 150 and 200° C.

9. The method for fabricating an electric cable for nuclear power plants according to claim 7,
wherein the temperature of a die head of an extruder is set between 390 and 410° C. to melt the PEEK material.

10. The method for fabricating an electric cable for nuclear power plants according to claim 9,
wherein the PEEK material becomes amorphous by applying a coolant between 0 and 10° C. at the quick cooling step.
